(19) United States
(12) Patent Application Publication
(10) Pub. No.: US 2025/0371484 A1
(43) Pub. Date: Dec. 4, 2025

(54) ASSOCIATION-BASED INTELLIGENT ASSET TRACKING

(71) Applicant: QUALCOMM Incorporated, San Diego, CA (US)

(72) Inventors: Gang DING, San Diego, CA (US); Joseph Patrick BURKE, Carlsbad, CA (US); Robert Thomas FRANZO, Northport, MI (US); Mandyam VIKRAM, San Diego, CA (US); Trilok Kumar AGRAWAL, San Diego, CA (US)

(21) Appl. No.: 19/212,489

(22) Filed: May 19, 2025

Related U.S. Application Data
(60) Provisional application No. 63/654,859, filed on May 31, 2024.

(51) Int. Cl. G06Q 10/0833

(52) U.S. Cl. CPC G06Q 10/0833

(57) ABSTRACT

Systems and techniques are described herein for association-based asset tracking. For instance, a computing device (e.g., an application server) can determine a plurality of associations among a plurality of assets. The computing device can monitor a plurality of messages being communicated corresponding to each association of the plurality of associations, detect an exception has occurred based upon the monitoring, and generate a notification based upon the detected exception. Each association of the plurality of associations can be created between two different assets of the plurality of assets. Each of the two different assets can be in a same mesh network or can be in different mesh networks.

### CROSS-REFERENCE TO RELATED APPLICATION

This application claims the benefit of U.S. Provisional Application No. 63/654,859, filed on May 31, 2024, which is incorporated herein by reference for all purposes.

### TECHNICAL FIELD

The present disclosure is generally related to asset tracking. For example, aspects of the present disclosure relate to association-based intelligent asset tracking.

### BACKGROUND

Shipping and delivery of assets (e.g., goods) is an important activity for many organizations. Organizations may want to keep track of and monitor assets being shipped. Tracking assets helps organization keep tabs on where the assets are and when they may arrive. Tracking and sensing devices (e.g., sensors) may be included with shipped assets to provide the tracking information. For example, sensors may be used at a vehicle/container level, pallet level, case level, etc., and often these sensors travel together. In many cases, the sensors are battery operated and are relatively low-cost devices. The different levels of sensors may provide different information about the environment and/or perform different tasks. For example, sensors on or within a case may monitor environmental conditions close to a product or sense whether individual cases are missing. Sensors at the pallet level, for example, may provide more advanced (e.g., earlier) information about potentially changing conditions as well as location information of the pallet. Sensors at the vehicle or container level may provide tracking or location information. Sensors may be grouped to help efficiently gather and distribute information.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for performing operations associated with an association-based intelligent asset tracking. In one illustrative example, an application server is provided. The application server includes at least one memory and at least one processor coupled to the at least one memory configured to: determine a plurality of associations among a plurality of assets, wherein each association of the plurality of associations is created between two different assets of the plurality of assets, wherein each of the two different assets is in a same mesh network or different mesh networks; monitor a plurality of messages being communicated corresponding to each association of the plurality of associations; detect an exception has occurred based upon the monitoring; and generate a notification based upon the detected exception.

In another example, a computer-implemented for association-based tracking an association-based intelligent asset tracking is provided. The method includes: determining a plurality of associations among a plurality of assets, wherein each association of the plurality of associations is created between two different assets of the plurality of assets, wherein each of the two different assets is in a same mesh network or different mesh networks; monitoring a plurality of messages being communicated corresponding to each association of the plurality of associations; detecting an exception has occurred based upon the monitoring; and generating a notification based upon the detected exception.

As another example, a non-transitory computer-readable medium is provided. The non-transitory computer-readable medium, when executed by at least one processor, causes the at least one processor to: determine a plurality of associations among a plurality of assets, wherein each association of the plurality of associations is created between two different assets of the plurality of assets, wherein each of the two different assets is in a same mesh network or different mesh networks; monitor a plurality of messages being communicated corresponding to each association of the plurality of associations; detect an exception has occurred based upon the monitoring; and generate a notification based upon the detected exception.

In another example, an application server is provided. The application server includes: means for determining a plurality of associations among a plurality of assets, wherein each association of the plurality of associations is created between two different assets of the plurality of assets, wherein each of the two different assets is in a same mesh network or different mesh networks; means for monitoring a plurality of messages being communicated corresponding to each association of the plurality of associations; means for detecting an exception has occurred based upon the monitoring; and means for generating a notification based upon the detected exception.

In some aspects, the apparatus comprises a mobile device (e.g., a sensor device, a mobile telephone or so-called “smart phone”, a tablet computer, or other type of mobile device), a wearable device, a personal computer, a laptop computer, a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with some examples.

FIG. 2 is a diagram illustrating example system including a shipping container, in accordance with aspects of the present disclosure.

FIG. 3 is a block diagram of a user equipment (UE), in accordance with aspects of the present disclosure.

FIG. 4 illustrates an example wireless communications system, in accordance with aspects of the present disclosure.

FIG. 5 illustrates an example of a closed loop produce distribution system, in accordance with aspects of the present disclosure.

FIG. 6 illustrates an example diagram of timing for association (e.g., when to perform association), in accordance with aspects of the present disclosure.

FIG. 7 illustrates an example diagram of networking among assets, in accordance with aspects of the present disclosure.

FIG. 8 illustrates a diagram of an example association-constrained asset networking, in accordance with aspects of the present disclosure.

FIG. 9 illustrates a diagram of an example of variants of association-constrained networking, in accordance with aspects of the present disclosure.

FIG. 10 illustrates a diagram of an example of exceptions for association-constrained networking, in accordance with aspects of the present disclosure.

FIG. 11 illustrates a flow-chart of an example method for association-based intelligent asset tracking.

FIG. 12 illustrates a diagram illustrating an example of a system for implementing certain aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Asset tracking is generally performed in a closed loop produce distribution system to obtain near-real time information of assets. The near-real time information of assets includes a plurality of transaction events, one or more process exception events, one or more fraud events, and/or one or more anomalies to generate an alert or alarm event. Additionally, near-real time information may also include other information such as location, environmental conditions, and/or other sensed information. Based on the near-real-time information of assets, a timely action may be performed

Receiving such near-real time information helps an organization to provide safe and cost-effective good transportation services. Near-real time information about assets being delivered is collected using sensors, which are also referenced herein as asset tracker devices or trackers. These trackers travel with the assets being delivered. However, because there may not be reliable external power sources available for the trackers, the trackers may be battery powered and relatively low powered devices. Further, different trackers may be used to provide different information for the corresponding assets being tracked. It may be useful to collect, integrate, and/or disseminate the collected information (or sensor data), while keeping battery usage within acceptable levels. To help coordinate activities and tasks among the trackers, the trackers may be organized into a mesh network, such as homogenous, hierarchal networks of trackers. The trackers may be organized into any other topology as suitable for specific purposes.

Systems and techniques are described herein for providing an association-based intelligent device (or asset) tracking. In some cases, tracker devices may be configured with a process flow (or operational flow) such as, an intended location history of the tracker device that identifies or represents an intended location history of an asset. Any exception in the process flow, or intended location history, may cause a process exception event to be generated and reported to the device (e.g., the server device) that is remote from the tracker devices (e.g., via a wide area network (WAN)). In some aspects, a fraud event (e.g., a loss of goods during transportation, an empty container, etc.) may also generate a process exception event (and/or an alert or alarm event) and transmit it to the device (or the server device) for an appropriate remedial action.

For instance, the process flow for which the tracker devices are configured may also include one or more professional operation flows, a manifest of a shipment, a list of exception events including, but not limited to, a fraud event, a theft event, etc. Tracking an asset based on the process flow can thus provide improvement to an asset tracking system. In some cases, the asset tracking system can provision a desired or expected process flow for each asset, improving delivery of an alert or alarm event to the device (e.g., the server device) for a timely remedial action.

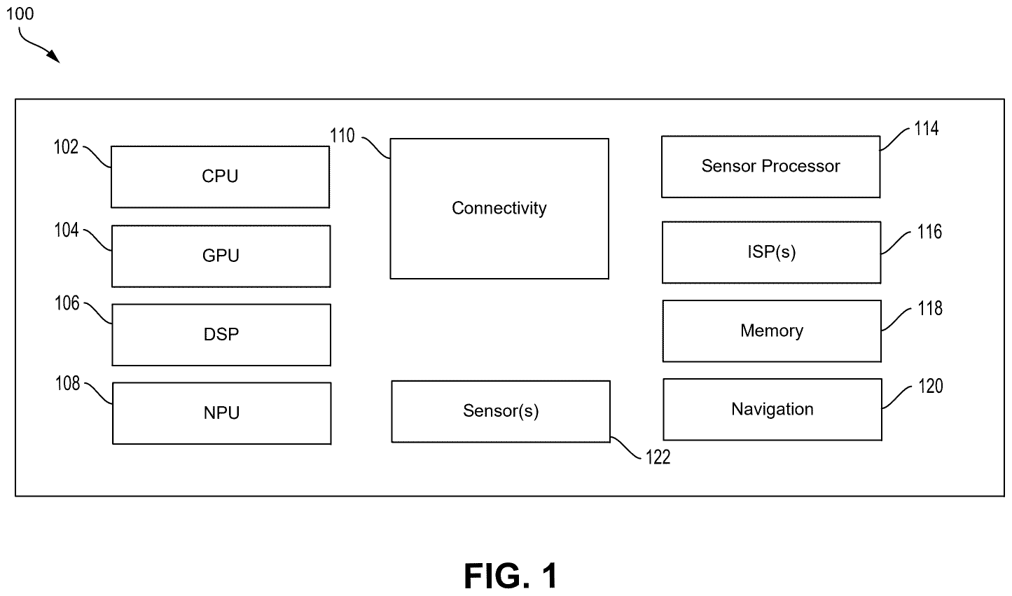

Various aspects of the present disclosure will be described with respect to the figures. FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, Ultrawideband (UWB) and the like. In one implementation, the NPU is implemented in the CPU 102, DSP 106, and/or GPU 104. The SOC 100 may also include a sensor processor 114, image signal processors (ISPs) 116, and/or navigation module 120, which may include a global navigation satellite system (GNSS) and/or global positioning system (GPS).

SOC 100 and/or components thereof may be configured to evaluate environmental conditions. For example, the sensor processor 114 may receive and/or process information from one or more sensors 122. Examples of sensors 122 may include one or more Inertial Measurement Units (IMUs) (e.g., an accelerometer, a gyroscope, etc.), temperature sensors, light sensors, shock sensors, humidity sensors, acceleration sensors, speed sensors, tilt angle sensors, etc. sensors of a device. In some cases, the sensors 122 may be located on SOC 100. In other cases, the sensor processor 114 may also be coupled to one or more sensors (not shown) that are external to the SOC 100 (e.g., located on a separate chip). In some cases, the sensor processor 114 may also receive, as input, output of one or more processing blocks of the connectivity block 110.

Moving assets, such as goods, parts, materials, etc., between locations is increasingly an important part of the global economy as supply chains spread out across states, countries, and continents. As moving assets become increasingly important, tracking shipped assets is also important to organizations as understanding when assets may arrive and in what condition those assets may be in can be useful for planning operations of the organizations.

To better track and understand environmental conditions assets may be exposed to as they move, sensor or asset tracking (e.g., tracker) devices may be included with the assets. These trackers may sense the environment around the tracker, gather location information, sense events, and the like. In some cases, the trackers may also periodically report the sensed data. In some cases, trackers may perform non-sensing functionality, such as gathering data from other trackers, command, and control operations, such as configuring trackers, scheduling operations of trackers, processing received data, transmitting data, relaying data for neighbor devices, and the like. In some cases, a tracker may include non-sensing functionality in addition to, or instead of the environmental sensing functionality. As the trackers may often be used to track moving assets, the trackers may be relatively low-powered, battery-operated devices. Additionally, trackers often may move in groups with multiple sensors distributed in strategic locations around the assets.

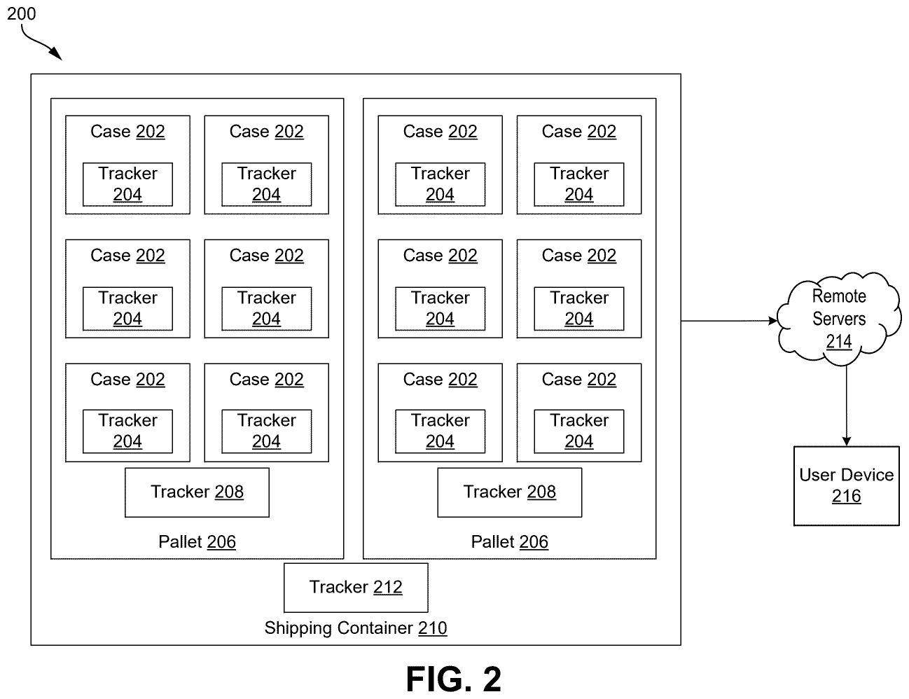

FIG. 2 is a diagram 200 illustrating an example of a system, in accordance with aspects of the present disclosure. As shown in diagram 200, assets (not shown) may be packed for shipping in one or more boxes or cases 202. In some examples, trackers 204 may be included with the assets in a case 202, or trackers 204 may be distributed in a certain percentage of the cases 202. The trackers 204 distributed in the cases 202 may sense environmental conditions within the cases 202, location of the individual cases 202, distribution of the cases 202, and the like. These cases 202 may be loaded onto pallets 206. In some cases, trackers 208 may be included on a certain percentage of the pallets 206 and these trackers 208 may sense environmental conditions around the cases 202 and/or pallets 206, location of the pallets 206, distribution of the pallets 206, and the like. In some cases, a number of cases 202 per pallet 206 may be known in advance based on a size of the cases 202, carrying capacity of the pallet 206, etc. The pallets 206 may in turn be loaded into a shipping container 210, a vehicle, and the like. The vehicle means any means of transportation including a truck, a car, a train, a boat, an airplane, etc. In some cases, trackers 212 may be included in, for example, the shipping container 210 and these trackers 212 may sense environmental conditions within or around the shipping container 210, location of the shipping container 210, and the like.

In some cases, information gathered from the trackers, such as trackers 204, 208, and 212, may be reported to one or more remote servers 214. The remote servers 214 may process the sensed data and provide the processed data to a user device 216. In some cases, the remote servers 214 may process the sensed data in addition to, or instead of any processing of the data that may be performed by the trackers. In some cases, this processed data may be provided to the user device 216 in near real time and the processed data may be provided continuously, periodically, on a schedule, on-demand, or at any other rate. In some cases, the rate at which data may be provided from the trackers 204 may be adjusted dynamically based on customer demands and hardware capability. As the trackers (e.g., trackers 204, 208, and 212) may be relatively low power devices, there may be a trade-off between sensing and reporting activities with battery life or tracker costs. Additionally, some activities, such as receiving and processing sensing data from other trackers or transmitting data to remote servers 214, may use more battery power than other activities, such as sensing.

In some cases, individual tracker devices may be set up for different roles and different costs. Different tracker hardware may be used based on costs and user needs. For example, for high-value assets, relatively more expensive trackers with more features may be used. As an example of these additional features, the relatively more expensive trackers may offer more granular reporting intervals, less latency, more sensing, and the like as compared to less expensive trackers. As another example, for shipments with a large number of assets with relatively stringent environmental concerns, many lower cost trackers may be distributed throughout the assets. These lower cost trackers may have less features than more expensive trackers but having more of the lower cost trackers may provide additional samples about conditions experiences across the assets. In some cases, a mixture of trackers may be used.

In diagram 200 includes an example of a mixture of trackers 204, 208, and 212 that may fall in three capability groups. A first group of trackers may be represented by trackers 204. As indicated above, tracker 204 may be used at a case 202 level and may be relatively low cost, with relatively less memory, processing power, and/or battery power as compared to other trackers (e.g., trackers 208 and 212). The trackers 204 may be set up primarily for sensing the environment, with short-range communications to participate in a relatively small network of devices.

A second group of trackers may be represented by trackers 208. Trackers 208 may be used at a pallet 206 level and may offer more capabilities, with relatively more memory, processing power, and/or battery power as compared to trackers 204, but relatively less memory, processing power, and/or battery power as compared to other trackers (e.g., trackers 212). In some cases, trackers 208 may be relatively more expensive than trackers 204, while less expensive than other trackers, such as tracker 212. Trackers 208 may be set up for additional sensing, data processing, and/or communications to maintain a relatively small network of devices (e.g., a network of trackers 204 on a pallet) and coordinate with other trackers, such as other trackers 208 and 212.

A third group of trackers may be represented by trackers 212. Trackers 212 may be used at the shipping container 210 level and may offer more capabilities, with relatively more memory, processing power, and/or battery power as compared to trackers 204 and 208. In some cases, trackers 212 may be tied into a power source for the shipping container 210. Trackers 212 may be set up for data processing, location sensing, and/or enhanced communications capabilities for communicating with, and/or managing, multiple local devices, associate with additional devices, and communicating with remote servers 214 via a wide area network.

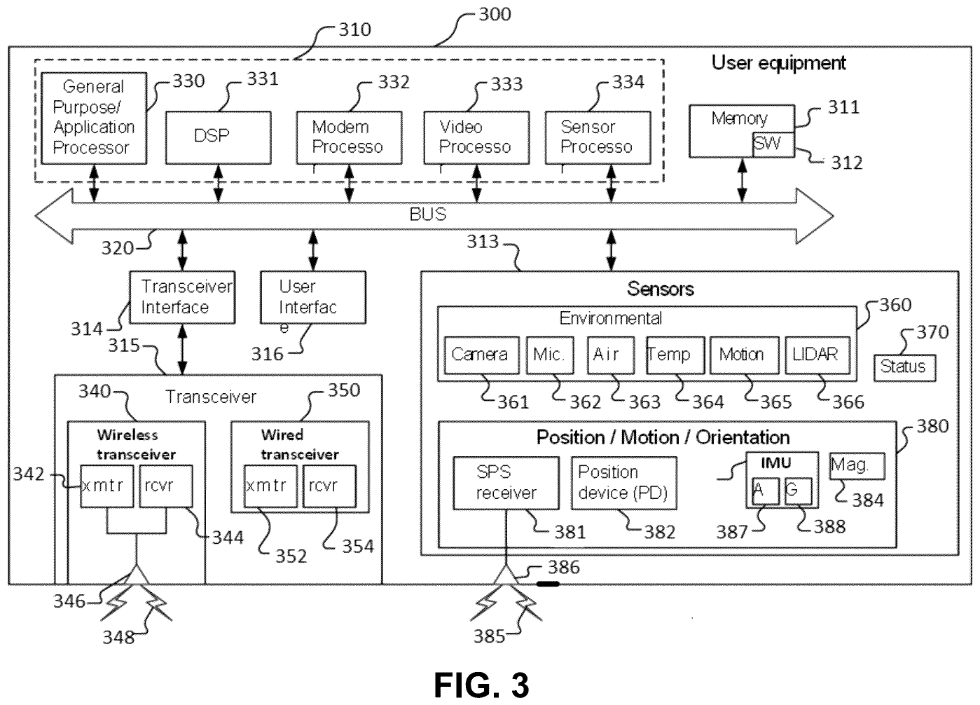

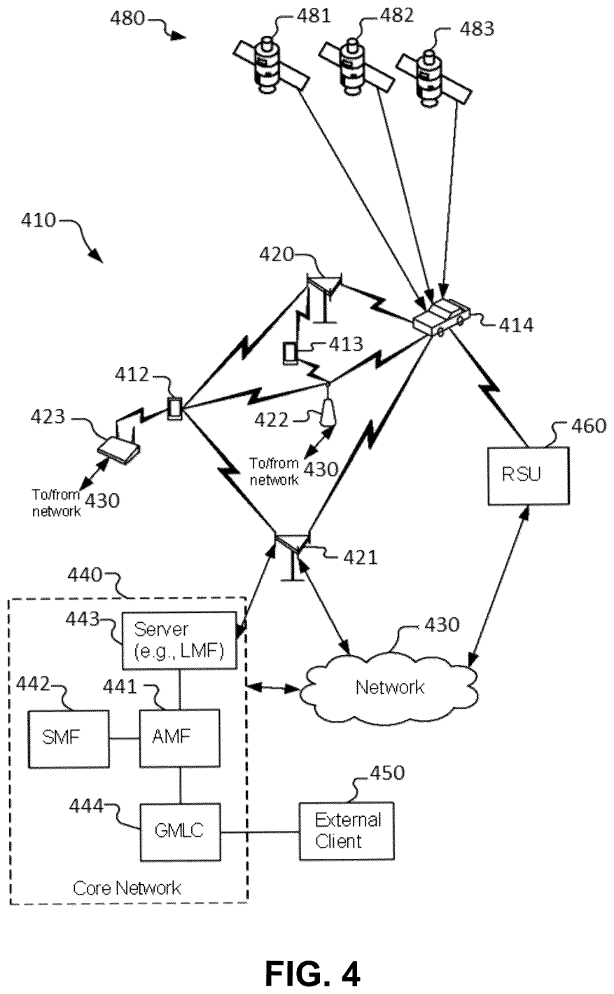

FIG. 3 is a block diagram of a UE 300, in accordance with aspects of the present disclosure. UE 300 may be an example of any of the UEs 412, 413, 414 (as shown below in FIG. 4) and comprises a computing platform including a processor 310, memory 311 including software (SW) 312, one or more sensors 313, a transceiver interface 314 for a transceiver 315 (that includes a wireless transceiver 340 and a wired transceiver 350), and a user interface 316. The processor 310, the memory 311, the sensor(s) 313, the transceiver interface 314, and the user interface 316 may be communicatively coupled to each other by a bus 320 (which may be configured, e.g., for optical and/or electrical communication). One or more of the components shown (e.g., one or more of the sensors 313, etc.) may be omitted from the UE 300.

The processor 310 may include one or more intelligent hardware devices, e.g., a central processing unit (CPU), a microcontroller, an application specific integrated circuit (ASIC), etc. The processor 310 may comprise multiple processors including a general-purpose/application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for radar, ultrasound, and/or lidar, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 300 for connectivity. The memory 311 is a non-transitory storage medium that may include random-access memory (RAM), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the UE 300 performing a function as shorthand for one or more appropriate components of the UE 300 performing the function. The processor 310 may include a memory with stored instructions in addition to and/or instead of the memory 311. Functionality of the processor 310 is discussed more fully below.

The configuration of the UE 300 shown in FIG. 3 is an example and not limiting the aspects and features of the disclosure, including the claims, and other configurations may be used. For example, an example configuration of the UE includes one or more of the processors 330-334 of the processor 310, the memory 311, and the wireless transceiver 340. Other example configurations include one or more of the processors 330-334 of the processor 310, the memory 311, the wireless transceiver 340, and one or more of the sensors 313, the user interface 316, and/or the wired transceiver 350.

The UE 300 may comprise the modem processor 332 that may be capable of performing baseband processing of signals received and down-converted by the transceiver 315 and/or the SPS receiver 381 (discussed below). The modem processor 332 may perform baseband processing of signals to be upconverted for transmission by the transceiver 315. Additionally, or alternatively, baseband processing may be performed by the processor 330 and/or the DSP 331. Other configurations, however, may be used to perform baseband processing.

The UE 300 includes the sensors 313 that may include one or more of various types of sensors, for example, an environmental sensor 360, a status sensor 370, and a position/motion/orientation (PMO) sensor 380. The PMO sensor 380 may include one or more sensors from which position and/or motion and/or orientation of the UE 300 may be determined. While each of the sensors 360, 370, 380 may be referred to in the singular, each of the sensors 360, 370, 380 may include more than one sensor, examples of some of which are discussed explicitly herein. The sensors 313 may generate analog and/or digital signals indications of which may be stored in the memory 311 and processed by the processor 310 (e.g., the processor 330, the DSP 331, the video processor 333, and/or the sensor processor 334 as appropriate) in support of one or more applications such as, for example, applications directed to positioning, navigation, and/or resource management. The description herein may refer to the processor 310 generally as performing one or more functions that one or more of the processors 330-334 perform.

The sensor(s) 313 may be used in resource management, relative location measurements, relative location determination, motion determination, etc. Information detected by the sensor(s) 313 may be used to determine how to allocate resources of the UE 300, e.g., transmission power, processing power for transmission and/or reception of communication signals, transmission, and/or reception directionality, etc. The plural term “resources” is often used throughout the discussion herein, but this term includes the singular as well, i.e., a single resource, e.g., being allocated. Additionally, or alternatively, information detected by the sensor(s) may be used for motion detection, relative displacement, dead reckoning, sensor-based location determination, and/or sensor-assisted location determination. The sensor(s) 313 may be useful to determine whether the UE 300 is fixed (stationary) or mobile and/or whether to report certain useful information to a server (e.g., server 214 of FIG. 2, server 443 of FIG. 4, etc.) regarding the mobility of the UE 300. For example, based on the information obtained/measured by the sensor(s) 313, the UE 300 may notify/report to the server 443 of FIG. 4 that the UE 300 has detected movements or that the UE 300 has moved, and report the relative displacement/distance (e.g., via dead reckoning, or sensor-based location determination, or sensor-assisted location determination enabled by the sensor(s) 313). In another example, for relative positioning information, the sensors/IMU can be used to determine the angle, size (e.g., width and/or height), and/or orientation of another device with respect to the UE 300, etc. The position and/or motion of the UE 300 may be used in determining resource allocation for communication, e.g., between vehicles. The UE 300 may, for example, be disposed in or integrated with a vehicle. For example, the UE 300 may be the UE 414 of FIG. 4 that is a vehicle, in the example shown in FIG. 4, a car, although other forms of vehicles may be used (e.g., trucks, aerial UEs such as drones, etc.). As such, the UE 300 may be configured for various forms of communication, such as vehicle-to-vehicle (V2V), vehicle-to-infrastructure (V2I), infrastructure-to-vehicle (12V), vehicle-to-network (V2N), and vehicle-to-pedestrian (V2P) communications, which are all collectively referred to as vehicle-to-everything (V2X) communications. In some aspects, the UE 300 may include a cellular interface (e.g., a cellular V2X (CV2X) interface) defined by the 3rd Generation Partnership Project (3GPP) Standard and/or dedicated short-range communications (DSRC) interface defined by the IEEE 802.11p Standard for V2X wireless communications.

The environmental sensor 360 may include one or more sensors for measuring one or more internal and/or external environmental conditions. In this example, the environmental sensor 360 includes a camera 361, a microphone 362, an air-flow sensor 363, a temperature sensor 364, a motion sensor 365, and a LIDAR (Light Detection and Ranging) sensor 366. While each of the sensors 361-366 may be referred to in the singular, each of the sensors 361-366 may include more than one sensor, examples of some of which are discussed explicitly herein. For example, the camera 361 may include at least one camera configured (e.g., designed, made, disposed, and directed) to capture images external to the UE 300 and/or may include one or more cameras configured to capture images internal to the UE 300 (e.g., in a passenger compartment of a vehicle). As other examples, the microphone 362, the temperature sensor 364, and/or the motion sensor 365 may include multiple microphones, multiple thermometers, and/or multiple motion detectors configured to detect sound, temperature, and/or motion (respectively) outside and/or inside of the UE 300, e.g., a vehicle. Indeed, any of the sensors 361-365 may include multiple respective sensors outside the vehicle and/or multiple respective sensors inside the vehicle for making respective measurements at multiple locations about the vehicle and/or in different directions relative to the vehicle. While this discussion assumes the UE 300 is a vehicle, the UE 300 may be a different device (i.e., other than a vehicle). The sensors 361-365 are examples and one or more of the sensors 361-365 may be omitted from the UE 300 and/or one or more other sensors may be included in the UE 300. For example, the environmental sensor 360 may include one or more barometric pressure sensors and/or one or more ambient light sensors and/or one or more other sensors.

The camera 361 may be configured for capturing still and/or moving imagery. For example, each camera of the camera 361 may comprise, for example, one or more imaging sensors (e.g., a charge coupled device (CCD) or a CMOS imager), one or more lenses, analog-to-digital circuitry, frame buffers, etc. Additional processing, conditioning, encoding, and/or compression of signals representing captured images may be performed by the general-purpose processor 330 and/or the DSP 331. In some cases, the video processor 333 may perform conditioning, encoding, compression, and/or manipulation of signals representing captured images. The video processor 333 may decode/decompress stored image data for presentation on a display device (not shown), e.g., of the user interface 316.

The motion sensor 365 is configured to detect motion. For example, the motion sensor 365 may send and receive sound waves (e.g., ultrasound signals) and analyze the received signals for Doppler effects indicative of motion. Use of multiple motion detectors may help identify the relative location (e.g., direction relative to the UE 300) of an object.

The LIDAR sensor 366 is configured to determine range to an object, which may be used by the processor 310 to detect the presence of an object. Use of multiple LIDAR sensors may help identify the relative location (e.g., direction relative to the UE 300) of an object. The LIDAR sensor 366 may be called a LADAR (laser radar) sensor, as is common when using a LIDAR sensor for detecting relatively small objects such as vehicles or other artificial (human-made) objects.

The status sensor 370 is configured to provide one or more indications of one or more UE conditions of the UE 300 indicative of UE status. For example, UE conditions where the UE 300 is a vehicle (with UE conditions thus being vehicle conditions) may include a gear status of the vehicle (e.g., whether the vehicle is in park, drive, or neutral, or in which gear the vehicle is presently (e.g., reverse, first, second, third, fourth, etc.)). Another vehicle condition may be whether an emergency brake is engaged. Another vehicle condition may be whether a main brake is presently engaged and possibly engaged to what degree. Another vehicle condition may be whether an accelerator is presently engaged and possibly to what degree. Another vehicle condition may be the status of the steering wheel (e.g., turned which way and how much) and/or wheel(s) directing the vehicle (e.g., direction of front wheels). Other example vehicle conditions may include whether a right-turn indicator is actuated, whether a left-turn indicator is actuated, and/or whether hazard lights (also called “four ways” or emergency flashers, etc.) are actuated. Another example of vehicle conditions may include tire status (e.g., tire pressure, rate of tire pressure change (e.g., to indicate a flat or blowout)). Another example of vehicle condition is speed, e.g., as registered by a speedometer of the vehicle and/or determined by other means (e.g., using the PMO sensor 380). These vehicle conditions are examples, and one or more other sensors may be provided to sense one or more other vehicle conditions. Further, numerous other UE conditions may be sensed and indicated where the UE 300 is not a vehicle or is not associated with a vehicle.

The PMO sensor 380 may include one or more sensors for providing one or more UE conditions such as, for example, vehicle conditions. For example, the PMO sensor 380 may include one or more sensors for measuring information from which position and/or motion and/or orientation of the UE 300 may be determined and possibly determining position and/or motion (e.g., speed and/or direction of motion) and/or orientation of the UE 300. In this example, the PMO sensor 380 includes a Satellite Positioning System (SPS) receiver 381, a position device (PD) 382, an Inertial Measurement Unit (IMU) 383, and a magnetometer 384. The components of the PMO sensor 380 shown are examples, and one or more of these components may be omitted and/or one or more other components included in the PMO sensor 380. Also, while each of the components 381-384 of the PMO sensor 380 may be referred to in the singular, each of the components 381-384 may include more than one such component, examples of some of which are discussed explicitly herein. Also, the PD 382 may be part of the SPS receiver 381 and/or the IMU 383 and/or part of the processor 310, and may not be a sensor itself (e.g., may not take measurements), but may process information from one or more of the sensors 381, 383, 384 and/or one or more other sensors. The PMO 380 may be used to determine UE speed and/or direction of motion, e.g., by determining UE location over time (e.g., determined using SPS, one or more ranging sensors, etc.).

The IMU 383 may comprise one or more inertial sensors, for example, an accelerometer 387 (e.g., responding to acceleration of the UE 300 in three dimensions) and/or a gyroscope 388. While each of the sensors 387, 388 may be referred to in the singular, each of the sensors 387, 388 may include more than one sensor. The accelerometer may include one or more three-dimensional accelerometers, and the gyroscope may include one or more three-dimensional gyroscopes. The IMU 383 may be configured to provide measurements about a direction of motion and/or a speed of motion of the UE 300, which may be used, for example, in relative location determination. For example, the accelerometer 387 and/or the gyroscope 388 of the IMU 383 may detect, respectively, a linear acceleration and a speed of rotation of the UE 300. The linear acceleration and speed of rotation measurements of the UE 300 may be integrated over time (e.g., by the IMU 383 and/or the PD 382) to determine an instantaneous direction of motion as well as a displacement of the UE 300. The instantaneous direction of motion and the displacement may be integrated to track a location of the UE 300. For example, a reference location of the UE 300 may be determined, e.g., using the SPS receiver 381 (and/or by some other means) for a moment in time and measurements from the accelerometer 387 and the gyroscope 388 taken after this moment in time may be used in dead reckoning to determine a present location of the UE 300 based on movement (direction and distance) of the UE 300 relative to the reference location.

The magnetometer 384 may determine magnetic field strengths in different directions which may be used to determine orientation of the UE 300, which may be used, for example, to provide a digital compass for the UE 300. The magnetometer 384 may include a two-dimensional magnetometer configured to detect and provide indications of magnetic field strength in two orthogonal dimensions. In some cases, the magnetometer 384 may include a three-dimensional magnetometer configured to detect and provide indications of magnetic field strength in three orthogonal dimensions. The magnetometer 384 may provide means for sensing a magnetic field and providing indications of the magnetic field, e.g., to the processor 310. The magnetometer 384 may provide measurements to determine orientation (e.g., relative to magnetic north and/or true north) that may be used for any of a variety of purposes, e.g., to support one or more compass applications. While referred to in the singular, the magnetometer 384 may include multiple magnetometers.

The SPS receiver 381 (e.g., a Global Positioning System (GPS) receiver or other Global Navigation Satellite System (GNSS) receiver) may be capable of receiving and acquiring SPS signals 385 via an SPS antenna 386. The antenna 386 is configured to transduce the wireless SPS signals 385 to wired signals, e.g., electrical or optical signals, and may be integrated with the antenna 346. The SPS receiver 381 may be configured to process, in whole or in part, the acquired SPS signals 385 for estimating a location of the UE 300. For example, the SPS receiver 381 may be configured to determine location of the UE 300 by trilateration using the SPS signals 385. The general-purpose processor 330, the memory 311, the DSP 331 and/or one or more specialized processors (not shown) may be utilized to process acquired SPS signals, in whole or in part, and/or to calculate an estimated location of the UE 300, in conjunction with the SPS receiver 381. The memory 311 may store indications (e.g., measurements) of the SPS signals 385 and/or other signals (e.g., signals acquired from the wireless transceiver 340) for use in performing positioning operations. The general-purpose processor 330, the DSP 331, and/or one or more specialized processors, and/or the memory 311 may provide or support a location engine for use in processing measurements to estimate a location of the UE 300. In some examples, some or all of the position determination signal processing may be performed by the PD 382.

The position device (PD) 382 may be configured to determine a position of the UE 300 (including absolute and/or relative position of the UE 300), motion of the UE 300, and/or time. For example, the PD 382 may communicate with, and/or include some or all of, the SPS receiver 381. The PD 382 may use measurements from the SPS receiver 381 and/or the IMU 383 and/or the magnetometer 384 to determine position and/or motion of the UE 300, e.g., using trilateration and/or dead reckoning. The PD 382 may work in conjunction with the processor 310 and the memory 311 as appropriate to perform at least a portion of one or more positioning methods (to determine location of the UE 300), although the description herein may refer only to the PD 382 being configured to perform, or performing, one or more operations in accordance with the positioning method(s). In some cases, the PD 382 may be configured to determine location of the UE 300 using terrestrial-based signals (e.g., at least some of signals 348 discussed below) for trilateration, for assistance with obtaining and using the SPS signals 385, or both. The PD 382 may be configured to use one or more other techniques (e.g., relying on the UE's self-reported location (e.g., part of the UE's position beacon)) for determining the location of the UE 300, and may use a combination of techniques (e.g., SPS and terrestrial positioning signals) to determine the location of the UE 300. The PD 382 may be configured to provide indications of uncertainty and/or error in the determined position and/or motion. Functionality of the PD 382 may be provided in a variety of manners and/or configurations, e.g., by the general purpose/application processor 330, the transceiver 315, the SPS receiver 381, and/or another component of the UE 300, and may be provided by hardware, software, firmware, or various combinations thereof.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more sidelink channels) and/or receiving (e.g., on one or more downlink channels and/or one or more sidelink channels) wireless signals 348 and transducing signals from the wireless signals 348 to wired (e.g., electrical and/or optical) signals and from wired signals to the wireless signals 348. The wireless transceiver 340 may be configured for wireless communication to send communications to, and receive communications from, a variety of entities such as other UEs, base stations, etc. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with TRPs (Transmission/Reception Points) and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), Wi-Fi, Wi-Fi Direct (WiFi-D), Bluetooth®, Zigbee etc. New Radio may use mm-wave frequencies and/or sub-6GHZ frequencies. The wired transceiver 350 may include a wired transmitter 352 and a wired receiver 354 configured for wired communication, e.g., a network interface that may communicate with the network 430 of FIG. 4, e.g., to send communications to, and receive communications from, a gNB, for example. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315.

The wireless transceiver 340 may be configured for beam management to affect directionality of the wireless transceiver 340, e.g., of the antenna 346. For example, the wireless transceiver 340 may be configured to implement beam forming for transmission and/or reception of the signals 348. The antenna 346 may include multiple antennas that are configured, e.g., designed, made, disposed, and directed to point in different directions relative to a body of the UE 300. One or more of such antennas may be capable of electronic beam steering (e.g., using appropriate phase shifts of elements of the antenna) and/or mechanical beam steering. In some examples, the transceiver 340 may be configured to selectively (e.g., under direction/control of the processor 310) transmit from one or more antennas and/or to selectively process signals (e.g., to pass from the transceiver 315 to the processor 310 or to process by the processor 310) received from one or more antennas.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the memory 311 to be processed by DSP 331 and/or the general-purpose processor 330 in response to action from a user. Similarly, applications hosted on the UE 300 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. In some examples, the user interface 316 may comprise one or more touch sensors responsive to touching and/or pressure, e.g., on a keyboard and/or touch screen of the user interface 316.

FIG. 4 illustrates an example wireless communications system 410, in accordance with aspects of the present disclosure. Wireless communications system 410 includes a user equipment (UE) 412, a UE 413, a UE 414, base transceiver stations (BTSs) 420, 421, 422, 423, a network 430, a core network 440, an external client 450, and a roadside unit (RSU) 460. The core network 440 (e.g., a 5G core network (5GC)) may include back-end devices including, among other things, an Access and Mobility Management Function (AMF) 441, a Session Management Function (SMF) 442, a server 443, and a Gateway Mobile Location Center (GMLC) 444. The AMF 441, the SMF 442, the server 443, and the GMLC 444 are communicatively coupled to each other. The server 443 may be, for example, a Location Management Function (LMF) that supports positioning of the UEs 412-414 (e.g., using techniques such as Assisted Global Navigation Satellite System (A-GNSS), OTDOA (Observed Time Difference of Arrival, e.g., Downlink (DL) OTDOA and/or Uplink (UL) OTDOA), Round Trip Time (RTT), Multi-Cell RTT, RTK (Real Time Kinematic), PPP (Precise Point Positioning), DGNSS (Differential GNSS), E-CID (Enhanced Cell ID), AoA (Angle of Arrival), AoD (Angle of Departure), etc.). The RSU 460 may be configured for communication (e.g., bi-directional or uni-directional communication) with the UEs 412-414). For example, the RSU 460 may be configured with similar communication capabilities to any of the BTSs 420-423, but perhaps with different functionality(ies) (e.g., different programming). Also, while one RSU 460 is shown in FIG. 4, the system 480 may include more than one RSU, or may not include any RSUs. The communication system 410 may include additional or alternative components.

The communication system 410 may utilize information from a constellation 480 of satellite vehicles (SVs) 481, 482, 483. The constellation 480 may correspond to a respective Global Navigation Satellite System (GNSS) (i.e., Satellite Positioning System (SPS)) such as the Global Positioning System (GPS), the GLObal NAvigation Satellite System (GLONASS), Galileo, Beidou, or some other local or regional SPS such as the Indian Regional Navigational Satellite System (IRNSS), the European Geostationary Navigation Overlay Service (EGNOS), or the Wide Area Augmentation System (WAAS). Only three SVs are shown for the constellation 480, but constellations of GNSS SVs will include more than three SVs.

An LMF may also be referred to as a Location Manager (LM), a Location Function (LF), a commercial LMF (CLMF), or a value-added LMF (VLMF). The server 443 (e.g., an LMF) and/or one or more other devices of the system 410 (e.g., one or more of the UEs 412-414) may be configured to determine locations of the UEs 412-414. The server 443 may communicate directly with the BTS 421 (e.g., a gNB) and/or one or more other BTSs, and may be integrated with the BTS 421 and/or one or more other BTSs. The SMF 442 may serve as an initial contact point of a Service Control Function (SCF) (not shown) to create, control, and delete media sessions. The server 443 (e.g., an LMF) may be co-located or integrated with a gNB or a TRP (Transmission/Reception Point), or may be disposed remote from the gNB and/or TRP and configured to communicate directly or indirectly with the gNB and/or the TRP.

The AMF 441 may serve as a control node that processes signaling between the UEs 412-414 and the core network 440 and provides QoS (Quality of Service) flow and session management. The AMF 441 may support mobility of the UEs 412-414 including cell change and handover and may participate in supporting signaling connection to the UEs 412-414.

The system 410 is capable of wireless communication in that components of the system 410 can communicate with one another (at least sometimes using wireless connections) directly or indirectly, e.g., via the BTSs 420-423 and/or the network 430 (and/or one or more other devices not shown, such as one or more other base transceiver stations). While the BTSs 420-423 are shown separately from the network 430, the network 430 may include one or more of the BTSs 420-423 and may constitute a Radio Access Network (RAN), e.g., a New Radio (NR) RAN which may also be called a Fifth Generation (5G) Next Generation (NG) RAN (NG-RAN). For indirect communications, the communications may be altered during transmission from one entity to another, e.g., to alter header information of data packets, to change format, etc. The UEs 412-414 may communicate with the BTSs 420-423 via Uu interfaces, e.g., in RRC-encapsulated LPP messages (Radio Resource Control encapsulated LTE Positioning Protocol messages) over Uu interfaces. The UEs 412-414 shown are a smartphone, a tablet computer, and a vehicle-based device, but these are examples only as the UEs 412-414 are not required to be any of these configurations, and other configurations of UEs may be used. The UEs 412-414, the BTSs 420-423, the network 430, the core network 440, and/or the external client 450. For example, such other devices may include internet of thing (IoT) devices, medical devices, home entertainment and/or automation devices, etc. The core network 440 may communicate with the external client 450 (e.g., a computer system), e.g., to allow the external client 450 to request and/or receive location information regarding the UEs 412-414 (e.g., via the GMLC 444).

The UEs 412-414 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (e.g., V2P (Vehicle-to-Pedestrian), V2I (Vehicle-to-Infrastructure), V2V (Vehicle-to-Vehicle), etc.), IEEE 802.81p, etc.). As noted previously, V2X communications may be cellular (C-V2X) and/or Wi-Fi (e.g., DSRC). The system 410 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc.

The BTSs 420-423 may wirelessly communicate with the UEs 412-414 in the system 410 via one or more antennas. A BTS may also be referred to as a base station, an access point, a gNode B (gNB), an access node (AN), a Node B, an evolved Node B (eNB), etc. For example, each of the BTSs 420, 421 may be a gNB or a transmission point gNB, the BTS 422 may be a macro cell (e.g., a high-power cellular base station) and/or a small cell (e.g., a low-power cellular base station), and the BTS 423 may be an access point (e.g., a short-range base station configured to communicate with short-range technology such as WiFi, WiFi-Direct (WiFi-D), Bluetooth®, Bluetooth®-low energy (BLE), Zigbee, etc. One or more of the BTSs 420-423 may be configured to communicate with the UEs 412-414 via multiple carriers. Each of the BTSs 420, 421 may provide communication coverage for a respective geographic region, e.g., a cell. Each cell may be partitioned into multiple sectors as a function of the base station antennas.

The BTSs 420-423 each comprise one or more Transmission/Reception Points (TRPs). For example, each sector within a cell of a BTS may comprise a TRP, although multiple TRPs may share one or more components (e.g., share a processor but have separate antennas). The system 410 may include only macro TRPs or the system 410 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

The UEs 412-414 may be configured to connect indirectly to one or more communication networks via one or more device-to-device (D2D) and/or peer-to-peer (P2P) links. The D2D P2P links may be supported with any appropriate D2D radio access technology (RAT), such as LTE Direct (LTE-D), WiFi Direct (WiFi-D), Bluetooth®, Ultrawideband (UWB), and so on. One or more of a group of the UEs 412-414 utilizing D2D communications may be within a geographic coverage area of a TRP such as one or more of the BTSs 420-423. Other UEs in such a group may be outside such geographic coverage areas, or be otherwise unable to receive transmissions from a base station. Groups of the UEs 412-414 communicating via D2D communications may utilize a one-to-many (8:M) system in which each UE may transmit to other UEs in the group. A TRP of the BTSs 420-423 may facilitate scheduling of resources for D2D communications. In other cases, D2D communications may be carried out between UEs without the involvement of a TRP using multiple types of communication interfaces, such as a V2X communication interface (e.g., using a C-V2X and/or DSRC communication interface), a Bluetooth communication interface, a WiFi communication interface, and/or other communication interface.

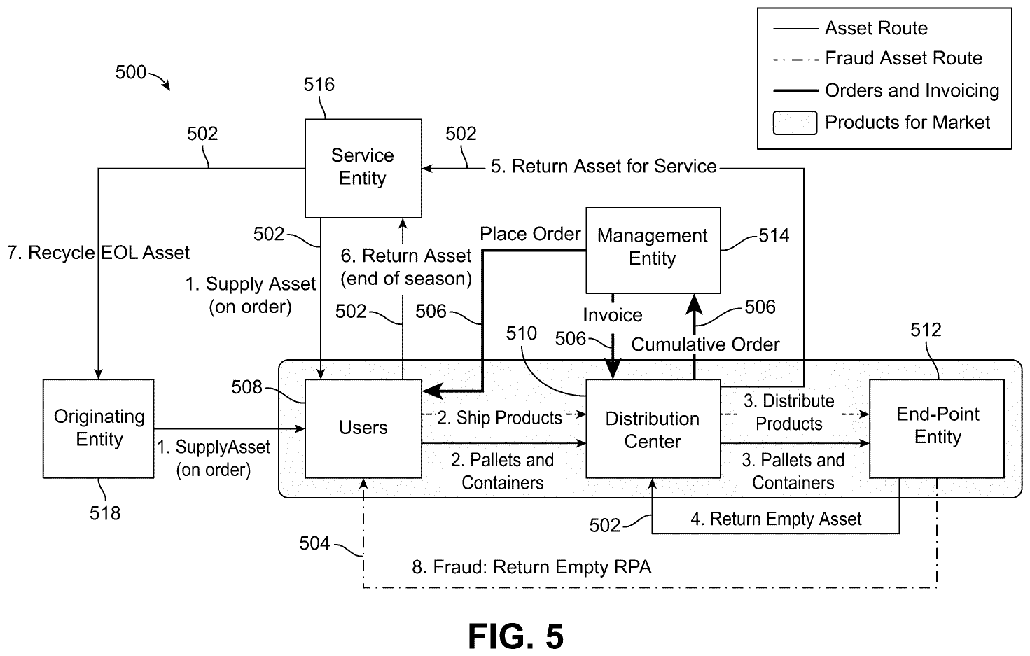

FIG. 5 illustrates an example of a closed loop product distribution system 500. The closed loop produce distribution system 500 monitors various events at low cost. By way of an example, various events being monitored include one or more transaction events, one or more process exception events, and/or one or more fraud events. As described herein, the one or more transaction events may include location reporting events, quality control events, and other operational optimizations related events. The one or more process exception events may include events such as when any asset that moves within the closed loop produce distribution system 500 not conforming to an operational path. The asset, as described herein, refers to a reusable asset such as a reusable plastic asset, a pallet (or a reusable plastic pallet), and/or a container (or a reusable plastic container). Generally, a pallet may include one or more containers, and one or more pallets may form an asset being loaded and transported using a vehicle (or any other mode of transportation).

In some examples, the asset, as described herein, may be a connected intelligent asset (CIA) that is configured with an algorithm (or a flow control logic or intelligence) for self-organizing and sensing various events using a respective sensor, and establishing trustworthiness to provide an alarm or a notification based on the sensed event. The alarm or notification based on the sensed event provides operation insights and augments operational productivity. Such configured connected intelligent assets (C-CIAs) include one or more CIA pallets, and each CIA pallet includes one or more CIA containers. Each C-CIA of the C-CIAs is configured to be identified in the CME by a Unique-ID (UID) Signature Vector (USV). The USV includes a UID for each CIA pallet, and a UID respective to each CIA container of each CIA pallet. The UID for each CIA pallet and the UID for each CIA container may be stored in a memory such as a Signature Registration Location (SRL) along with a date and/or a timestamp associated with a Signature Registration Time (SRT).

FIG. 5 shows three different operational paths including a first path 502, a second path 504, and a third path 506. The first path 502 illustrates a desired or expected operational path, the second path 504 illustrates a route for an asset for which fraud is suspected or detected, and the third path 506 illustrates a path for ordering and invoicing operations. Various entities involved in the operational paths shown in FIG. 5 include users 508, a distribution center 510, an end-point entity 512 (e.g., a point of sale, retail store, etc.), a management entity 514 receiving order details and generating invoices, a service entity 516, and an originating entity 518 (e.g., manufacturer of assets). Users 508 may include entities transporting shipments to other entities upon receiving order requests.

The service entity 516 provides pallets and/or containers to the users 508 upon receiving an order from the users 508 and receives the pallets and/or containers back from the users 508, for example, upon end of the season or when the purpose for the pallets and/or containers is served. The service entity 516 may fix and clean the pallets and/or containers, if needed. In some aspects, the users 508 may also receive the pallets and/or containers from the originating entity 518.

Subsequently, the users 508 may ship products to the distribution center 510 using the container and/or the pallet. The distribution center 510 may further transport the products using the container and/or the pallet to the end-point entity 512. At the end-point entity 512, the pallet and/or the container are emptied, and the empty container and/or pallet are returned back to the distribution center 510. However, if a container and/or pallet is determined to have an issue, for example, a fraud, the container and/or pallet (or the asset, as described herein) is sent to the users 508 from or by the end-point entity 512.

Upon receiving the empty container and/or pallet at the distribution center 510 from the end-point entity 512, the container and/or pallet (or the asset, as described herein) is transported to the service entity 516. The service entity 516 may send the pallet and/or container to the originating entity 518 for recycling upon end-of-life for the pallet and/or container (or the asset, as described herein).

However, in the closed loop produce distribution system 500, when an asset does not follow a desired operational path, no information is immediately available to remedy the issue. Various aspects, as described herein, provide association based intelligent asset tracking systems and techniques that solve the issues in the closed loop produce distribution system 500.

In some aspects, an association is derived from regular operation flows (e.g., operation flows), from a manifest for a shipment, from exception events (e.g., fraud, theft, etc.), any combination thereof, and/or from other items or events. In some aspects, the association also dictates underlying networking. For instance, in some cases, not every asset is allowed to participate in all networking activities. In another example, activities that break the association may trigger anomaly and/or exception alerts.

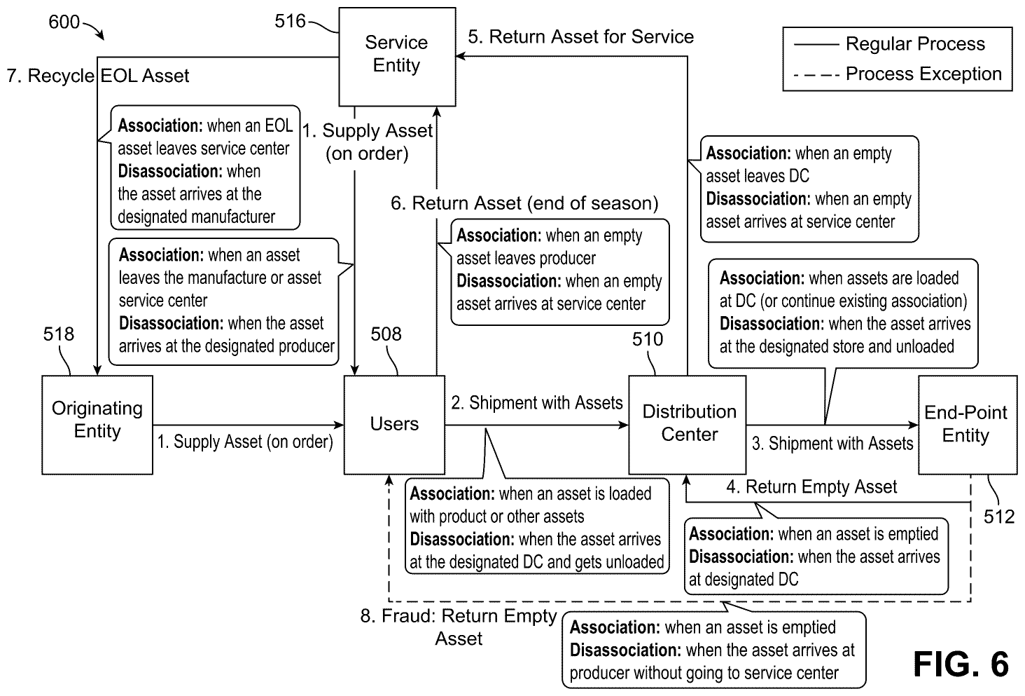

FIG. 6 illustrates an example diagram 600 of timing for association (e.g., when to perform association). As illustrated in FIG. 6, an association and/or a disassociation can be derived and updated based on defined flows (e.g., business flows). For example, when there is a shipment manifest, the association can be derived from assets defined in the manifest. Further, based upon a start time and/or an end time, an association and a disassociation, respectively, can be triggered. Additionally, from waypoints (or entities the users 508, the distribution center 510, the end-point entity 512, the service entity 516, and the originating entity 518 shown in FIG. 5) that the assets are expected to pass through, and/or from one or more destinations (such as the users 508, the distribution center 510, the end-point entity 512, the service entity 516, and the originating entity 518 shown in FIG. 5) to which the assets have to be delivered, any combination thereof, and/or from other items or events.

In some aspects, an association is added, updated, and/or removed/deleted using an asset tracking service. The asset tracking service implements the flows based upon manifests and/or data received from a plurality of sensors. For example, a user (e.g., a customer) may manually add, delete, and/or update the association between assets. In another example, the user (e.g., customer) can define conditions, such as when, where, and other logics, to automatically associate assets. In another example, an association can be added, deleted, and/or updated based on a manifest being imported and enforced to a shipment of assets, an asset being delivered at pre-determined destination, detection of an asset in motion or stationary, detection of an asset being indoor or outdoor, detection of an asset being folded or unfolded, detection of an asset being empty or non-empty, detection of loading/unloading an asset, detection of the proximity of an asset to another asset, any combination thereof, and/or other event or action. As described herein, the asset refers to the container, the pallet, and/or a collection of pallets.

As shown in FIG. 6, when an order is received at the users 508 from the service entity 516 and/or the originating entity 518, an association (or a first association) is created/added when an asset leaves the service entity 516 and/or the originating entity 518, and the association (or the first association) is removed/deleted when the asset arrives at the intended or designated user 508. Next, another association (or a second association) is created/added when the asset (e.g., pallet(s), and/or container(s)) is loaded with product(s) or other assets, and the other association (or the second association) is removed/deleted when the asset arrives at a designated or intended distribution center 510.

Next, upon arrival of the asset at the distribution center 510, the asset may be loaded for transporting to the end-point entity 512, at which time another association (or a third association) is created/added. Alternatively, the second association may be updated to indicate its next destination to be the end-point entity 512. The third association (or the updated second association) is dissolved or removed when the asset arrives at the intended or designated end-point entity 512.

At the end-point entity 512, the asset may be unloaded and then transported back to the distribution center 510 at which time another association (or a fourth association) is created. The fourth association may be removed when the asset arrives back at the distribution center 510 from the end-point entity 512. However, upon unloading the asset at the end-point entity 512, it may be detected that the asset includes products that fail to meet the desired quality standards, or desired quantity or type of products, etc., then the asset may be returned back to the users 508 by the end-point entity 512 and a new association (or a fifth association) may be created. The new association (or the first association) is removed or deleted when the asset arrives at users 508 (without going back to, or through, the service entity 516).

As shown in FIG. 6, the asset arrived back at the distribution center 510 from the end-point entity 512 is transported to the service entity 516 and an association (a sixth association) is created when the (empty) asset leaves the distribution center 510 for the service entity 516. The association (or the sixth association) is removed or deleted when the asset (or empty asset) arrives at the service entity 516. The asset arriving at the service entity 516 may be reused and upon determining the asset has reached an end-of-life, the asset may be returned to the originating entity 518. While returning the asset from the service entity 516 to the originating entity 518, another association (or a seventh association) may be created, which is removed when the asset arrives at a target originating entity 518.

In some cases, the users 508 may create an association (or an eighth association) while transporting the asset back to the service entity 516, and the association (or the eighth association) is removed when an empty asset arrives at the service entity 516.

As described herein, the asset here means to be a pallet and/or a container.

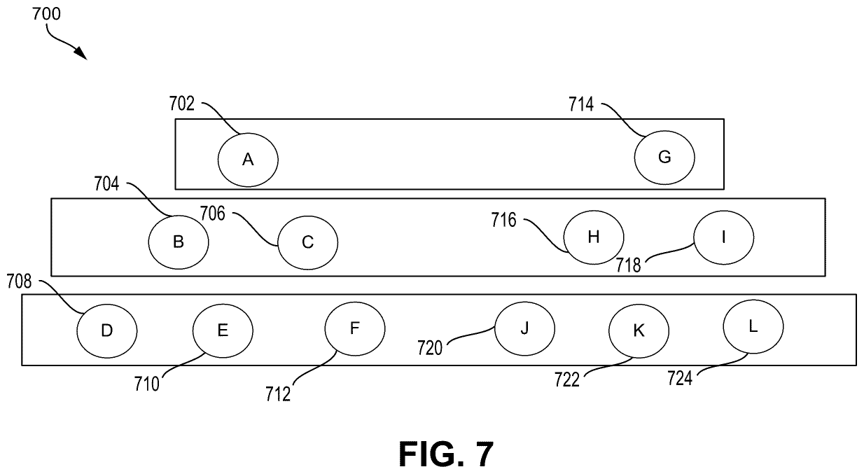

FIG. 7 illustrates an example diagram 700 of networking among assets. As described herein, an asset can include a pallet and/or a container. The diagram 700 illustrates a relationship among assets, and how the assets communicate with each other.

As shown in FIG. 7, an asset A 702 may correspond with a vehicle A (e.g., a truck, a train, etc.), which loads a pallet B 704 and a pallet C 706. The pallet B 704 and/or the pallet C 706 may further include (e.g., hold) one or more containers such as containers 708, 710, and/or 712. Similarly, there may be another vehicle G (or asset G) 714. The vehicle G 714 may be traveling together with the asset A 702, loading another set of pallets 716 and/or 718 and container 720, 722, and/or 724. Accordingly, as shown in FIG. 7, and as described herein, a pallet includes one or more containers, and a vehicle is loaded with one or more pallets. However, the pallet and/or the container may also be referenced herein as an asset. Accordingly, a hierarchy of assets exist, and assets at each different hierarchy level may communicate with other assets at the same and/or another hierarchy level using different communication protocols.

In some aspects, assets A 702 and G 714, which may be vehicles as described previously, may communicate with each other using a vehicle-to-everything (V2X) communication protocols (e.g., a vehicle-to-vehicle (V2V) communication protocol). V2X communication utilizes wireless technologies, such as a Dedicated Short-Range Communication (DSRC) interface or a cellular interface (for C-V2X). Accordingly, asset A 702 and asset G 714 may form a peer-to-peer mesh network, allowing them to communicate directly with each other within a certain range for sharing information such as status of location, environmental condition, details about other assets (such as assets 704, 706, 708, 710, and/or 712, and assets 716, 718, 720, 722, and/or 724).

In some aspects, assets 704 and 706 may communicate with each other using a mesh network (e.g., a Wi-Fi mesh network), and assets 716 and 718 may communicate with each other using another mesh network (e.g., another Wi-Fi mesh network). Further, assets 708, 710, and/or 712 may communicate with each other using a mesh network (e.g., a Bluetooth Low Energy (BLE) mesh network), and assets 720, 722, and/or 724 may communicate with each other using another mesh network (e.g., another BLE mesh network).

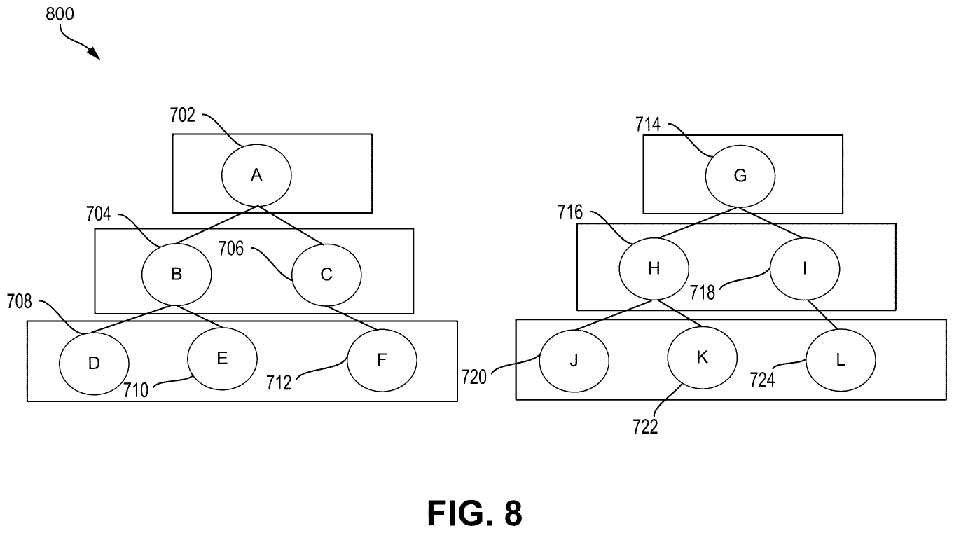

Further, an asset may be configured to support more than one different type of mesh network and thereby communicate with an asset at different hierarchical level as shown in FIG. 8 below.

FIG. 8 illustrates a diagram 800 of an example association-constrained asset networking. As shown in FIG. 8, in some aspects, at least one asset at a first hierarchical level may be configured to communicate with at least one asset at a second hierarchical level. For example, assets (or containers) 708 and 710 are configured to communicate with asset (or pallet) 704, and asset (or container) 712 is configured to communicate with asset (or pallet) 706. Further, each of assets 704 and 706 is configured to communicate with asset A 702 (e.g., a vehicle). Similarly, assets (or containers) 720 and 722 are configured to communicate with asset (or pallet) 716, and asset (or container) 724 is configured to communicate with asset (or pallet) 718. Further, each of assets 716 and 718 is configured to communicate with asset (or vehicle) 714.

Accordingly, assets 708, 710, 712, 720, 722, and 724 are configured to support and communicate using more than one communication protocol, such as, BLE and Wi-Fi mesh protocols. Similarly, assets 704 and 706 are configured to support and communicate using more than one communication protocol, such as, BLE and Wi-Fi mesh networks, while acting as intermediate assets, to communicate status about assets 708, 710, 712 to asset 702 and to a central entity (e.g., an application server, which can operate as mission control or other central location or entity, such as one or more server devices) via one or more of 3G, 4G, 5G, 6G, WiMax, LAN, WAN, or another asset (e.g., asset 714) using V2V communication technique, etc. Similarly, assets 716, and 718 are configured to support and communicate using more than one communication protocol, such as, BLE and Wi-Fi mesh networks, while acting as intermediate assets, to communicate status about assets 720, 722, and 724 to asset 714 and to the central entity via one or more of 3G, 4G, 5G, 6G, WiMax, LAN, WAN, or another asset (e.g., asset 702) using V2V communication technique, etc.

Thus, in some aspects, at network layer and below, all assets may run one or multiple mesh networking protocols to route data packets among them. In some aspects, any other type of communication (e.g., mesh) systems may be used. In some cases, the assets may communicate across different asset types as far as they support the same communication hardware and networking protocol. In some aspects, association between assets can be added on top of any network running any network routing protocol, as discussed below.

Accordingly, in some aspects, association links can be added to connect assets that are directly associated with each other. A tree-like association structure is shown in FIG. 8; however, the actual association is not limited to a tree structure. Further, any two assets are associated if there is a path between them, which in some cases may involve intermediate nodes. The underlying networking can be constrained to only those assets which have a validated association. For example, any packets originated from assets under asset 702 (including asset 704, asset 706, asset 708, asset 710, and asset 712) cannot route through assets associated under asset 714 (including asset 716, asset 718, asset 720, asset 722, and asset 724) because assets associated under asset 714 belong to a different network (e.g., a different mesh network) than the network (e.g., mesh network) including the asset 702 and assets associated under asset 702. In such an example, packets originating from any of assets 704-712 can be routed through any of the other assets 704-712 (e.g., a packet originating from asset 712 can be routed by asset 704 or asset 706 to asset 702). Similarly, packets originating from any of assets 716-724 can be routed through any of the other assets 716-724 (e.g., a packet originating from asset 722 can be routed by asset 716 or asset 718 to asset 702).

For any two assets (in the same hierarchical layer or across different hierarchical layers) that are connected with each other, an association between the assets is kept active through a periodic messaging between the assets, which may be referred to as association messages. For instance, an association between assets can remain active as long as an association message is communicated between the assets. In some aspects, the periodic messaging may not only keep the association active, but may also deliver or communicate control and/or context information for providing location information, any exception event related information, etc. between the assets. The periodically transmitted association messages can be sent at an adjustable time interval based on communication/compute/power conditions, as shown in Eq. 1 below:

$$NextMessageTime ( association ) = K \frac{MessagePayloadSize}{DataRate * min ( BatteryLevel of associated assets )} \qquad Eq . 1$$

According to Equation 1, the periodicity (or time interval or frequency) of the association messages communicated between assets can be based on a payload size, a data rate (denoted DataRate in Equation 1), and battery life of the assets (e.g., due to the need for an asset to wake up from a low-power state and process the association messages). For instance, if the payload is small and/or the battery level is large, the association messages can be sent more often (with a higher periodicity or frequency) between associated assets. However, if one or more of the assets have low battery and/or the message payload is large, the association messaging periodicity may be lowered.

In some cases, each association between two assets can be monitored continuously or periodically. Any association defined or provisioned for a specific flow that is removed (e.g., due to one or both assets association with the association being removed from the vehicle, or having other issues such as low battery, etc.), or that becomes inactive (e.g., for not receiving communication messages from another asset for a particular time duration), can be reported as a notification or an alarm to a central entity (e.g., an application server) to take an appropriate corrective action. Additionally, the defined or provisioned specific flow also states other conditions (or restrictions) when a notification or an alert shall be generated for an appropriate corrective action.

In FIG. 8 (and other similar drawings), each association between two assets that is being monitored is shown as a connecting line between the assets. If there is no connecting line between the assets, then either there is no connection between the assets through any of the communication protocols, described herein, or the connection is not monitored.

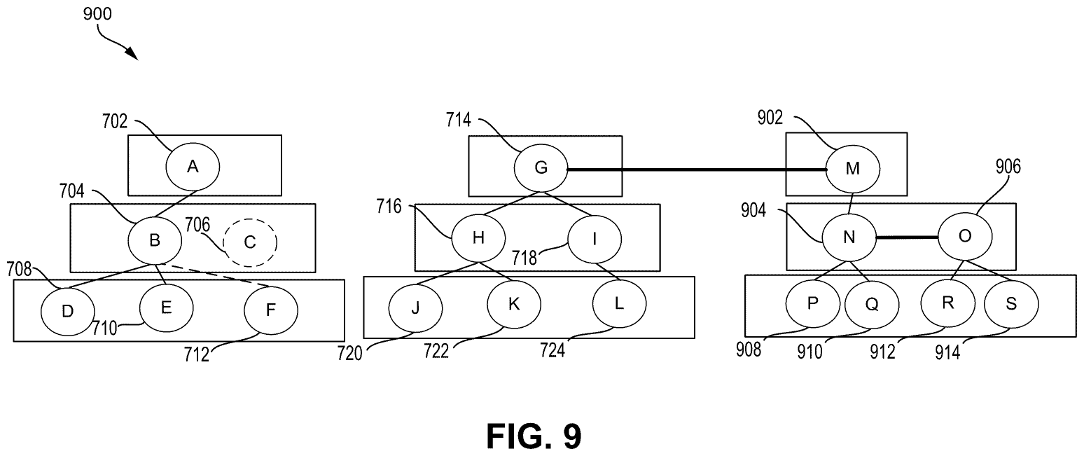

FIG. 9 illustrates a diagram 900 of an example of variants of association-constrained networking. For instance, association is an application layer concept. Even when an association puts a constraint on the underlying network, it does not change the network protocol itself or the dynamics of the underlying mesh network. For example, as illustrated in FIG. 9, when asset C (or asset 706) is delivered, has a low battery state, gets lost, or another event occurs with respect to asset C, the network (e.g., a central entity, such as an application server) can respond as it normally does so that data to/from asset F (or asset 712) may still get routed via asset B (asset 704).

In some cases, association can also happen between the same type of assets, for example between vehicle G (or asset 714) and vehicle M (or asset 902) as shown in FIG. 9, so that the two groups of assets transported by vehicle G and vehicle M are allowed to network across them. This can be beneficial when the two asset groups are located close to each other or travelling together.

In some aspects, associations can be defined for reasons other than following a given purpose (e.g., a specific process). For example, pallets N and O (or assets 904 and 906, respectively) may be shipped to different destinations so they do not have any association with a particular entity. But since they both are being transported in the same vehicle M (or asset 902), a system generated association can be added so that all assets (or containers 908, 910, 912, and 914) associated with pallets N and O (or assets 904 and 906, respectively) can network among themselves.

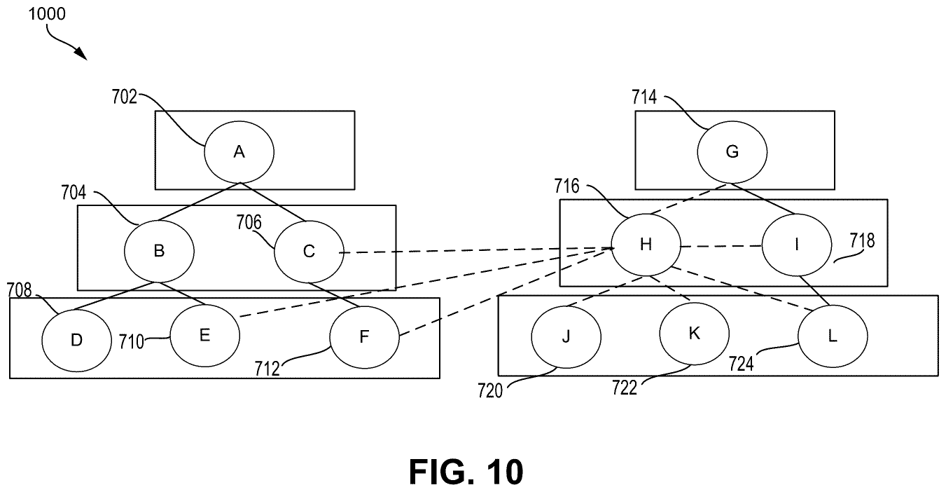

FIG. 10 illustrates a diagram 1000 of an example of exceptions for association-constrained networking. In some aspects, one or more exceptions may be added to bypassing an association, such as when packets are encrypted and authenticated to be relayed without being compromised, when delivering a packet efficiently is at higher priority than association, or when an asset or a group of assets have more capacity to participate in networking.

In one illustrative example, if asset H (or asset 716) has a larger battery and is able to handle more communications, it may take more network responsibilities (e.g., by transmitting and receiving messages to/from other assets) without the constraint of association. Accordingly, assets 706, 710, 712 may communicate with asset 716, and assets 718, 720, 722, and 724 may communicate with asset 716.

In some aspects, an association can be bypassed based upon a cost function as defined using Eq. 2 below:

$$CostFunc ( asset ) = \frac{NeighborDensity * BatteryLevel}{TimeWhenNotAssociated} \qquad Eq . 2$$

In Eq. 2 above, NeighborDensity may be computed as (a number of neighbors within a communication range of the asset)/(a given area around the asset), and TimeWhenNotAssociated may correspond with the time that the asset is not required to be associated with another asset under a particular process flow. Thus, if an asset has available resources (e.g., a large amount of available resources) and is mostly required to be associated with another asset, then the cost function for the asset would be higher, in which case the asset can be powered on most of the time to facilitate networking with neighboring assets (e.g., irrespective of a constraint specified by the process flow).

When the computed cost function using the above equation is greater than a preconfigured or configurable threshold value (e.g., CostFunc(asset)>a configurable threshold) and the asset meets all security and communication requirements, the association may be bypassed.

In some aspects, an exception event may be detected based upon the periodic messaging between assets. For example, an exception event (or all exception events) can be detected based on the regularly or periodically exchanged association messages over all active associations. As described herein, association messages include information such as identifiers of the associated assets, process flow (e.g., business flow) identifier, source, and destination, message frequency, etc.

Accordingly, in one example, a general process exception event can be detected whenever an active association has lost association messages. For instance, for a container (e.g., asset 712) associated with a pallet (e.g., asset 706) during a shipment from a producer to a distribution center (DC), an active association between them may be bound to, or according to, a process flow #2. If it is detected that the container (e.g., asset 712) has stopped communicating with the associated pallet (e.g., asset 706) at their regular messaging time, then an exception alert can be raised.

Similarly, in another example, a fraud event can be detected by checking the source of a current association. When a producer (such as the users 508 shown in FIG. 5) receives an empty asset, it can check whether the source is the service center (such as the service entity 516 shown in FIG. 6) or not. If the source is not the service center, a fraud alert can be raised.

In yet another example, an alert event can be detected by checking whether an active association link is based on a validated regular association message. Whenever it is missed, compromised, or fails the security check, an anomaly alert can be raised with more context about the alert, such as when, where, and which assets and process flows are involved in this alert.

As described herein, a general asset tracking solution is provided that closely monitors a particular process by enforcing associations between assets. Associations can be defined and updated based on the actual flows. Associations can be triggered by various means, including humans, sensors, and predefined logics. Associations can put a constraint on the underlying network. Events can be monitored with anomaly detection based on the enforced associations. The systems and techniques provided herein are described in the context of a closed loop produce distribution system. However, the systems and techniques can be used to track other processes.

In some aspects, constraints such as capacity constraints, routing constraints, resource constraints, and flow conservation may be provided for one or more flows in order to optimize lower network layers. In some cases, lower network layers may be optimized by influencing distribution of data and resources such that the data traverses through specific paths (or associations) and assets, and therefore through routes that utilize resources more efficiently. As a result, bandwidth utilization may be improved along with reduced latency and improved overall network performance.

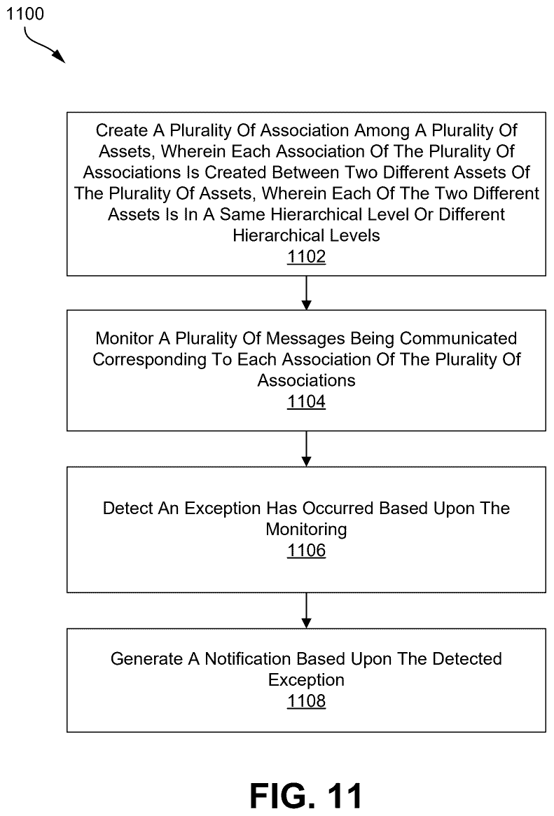

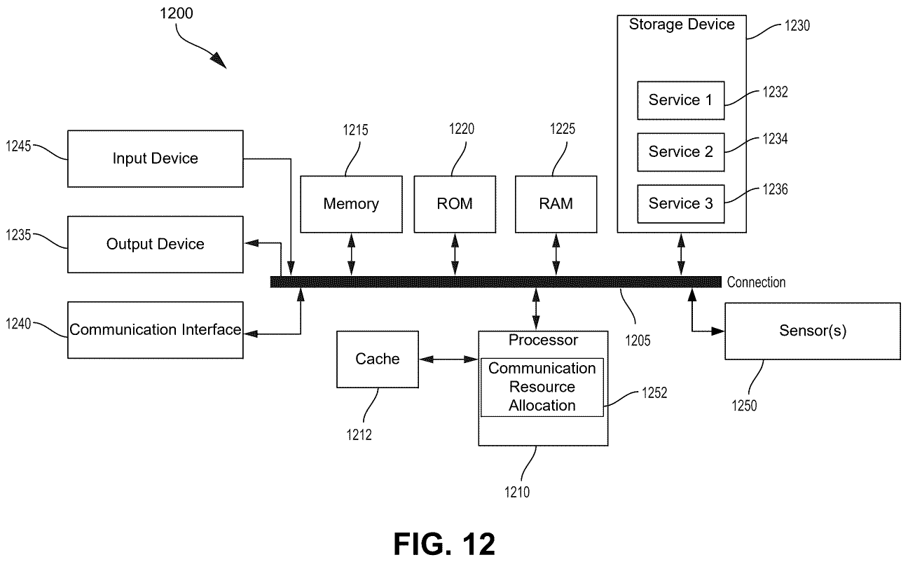

FIG. 11 illustrates a flow chart illustrating an example of a process 1100 for providing association-based asset tracking. In some examples, the process 1100 can be performed by a computing device or apparatus (e.g., an application server), or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 1100 may be implemented as software components that are executed and run on one or more processors (e.g., processor 1210 of FIG. 12 or other processor(s)). In some examples, the process 1100 can be performed by a machine learning network, including any of the machine learning networks and/or neural networks described herein, etc. In some aspects, the process 1100 can be performed by a UE, smartphone, mobile computing device, user computing device, etc. The process 1100 may be performed by an apparatus that may be a user device, central entity (e.g., an application server), or another device. The operations of the process 1100 may be implemented as software components that are executed and run on one or more processors (e.g., processor 1210 of FIG. 12, and/or other processor(s)).

At block 1102, the computing device (or a component thereof) may determine a plurality of associations among a plurality of assets. Each association of the plurality of associations is created between two different assets of the plurality of assets. Further, each of the two different assets may be in the same mesh network or different mesh networks. The plurality of associations is created in accordance with a plurality of operational flows. An operation flow of the plurality of operational flows describes movement of an asset across a plurality of entities of the operational flow.

Further, the plurality of associations may be determined in accordance with one or more of: manifestation of a shipment corresponding to the asset, and a plurality of exception events. The plurality of exception events includes a theft of the asset, a fraud, and/or an unexpected event.

In some cases, the plurality of associations may be determined to be active for a time period that is defined by a start time and an end time, and an association of the plurality of associations may be removed or terminated when an asset associated with the association arrives at a destination.

As described herein, each association of the plurality of associations may be configured to allow communication between two assets in the same mesh network or different mesh networks using at least one of a plurality of communication protocols at an adjustable time interval. The plurality of communication protocols may include at least one of a vehicle-to-vehicle communication protocol, a vehicle-to-everything communication protocol, a Wi-Fi mesh protocol, or a Bluetooth low energy mesh protocol. The adjustable time interval may be based on a message payload size, a data rate, and a respective battery level corresponding to the two different assets of each association.

In some cases, a first asset of the two different assets of the plurality of assets may include one of a vehicle, a pallet, or a container, and a second asset of the two different assets of the plurality of assets may include another one of the vehicle, the pallet, or the container.

In some cases, a first asset of the two different assets of the plurality of assets may include a first vehicle, a first pallet of the first vehicle, or a first container of the first pallet, and a second asset of the two different assets of the plurality of assets may include a second vehicle, a second pallet of the second vehicle, or a second container of the second pallet.

At block 1104, the computing device (or a component thereof) may monitor a plurality of messages being communicated corresponding to each association of the plurality of associations.

At block 1106, the computing device (or a component thereof) may detect an exception has occurred based upon the monitoring. Further, based upon monitoring of the plurality of messages, a plurality of events or exceptions may be detected. By way of an example, the plurality of events or exceptions may include at least one of a determination that an asset is stationary, that the asset is moving, that the asset is in an indoor environment, that the asset is in an outdoor environment, that the asset is empty, that the asset is non-empty, that the asset is folded, that the asset is unfolded, that the asset is being loaded, that the asset is being unloaded, or that the asset being in proximity with another asset.

At block 1108, the computing device (or a component thereof) may generate a notification based upon the detected exception.

FIG. 12 illustrates an example computing device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 1200 may include SOC 100 of FIG. 1. The components of computing device architecture 1200 are shown in electrical communication with each other using connection 1205, such as a bus. The example computing device architecture 1200 includes a processing unit (CPU or processor) 1210 and computing device connection 1205 that couples various computing device components including computing device memory 1215, such as read only memory (ROM) 1220 and random-access memory (RAM) 1225, to processor 1210.

Computing device architecture 1200 may include one or more sensors 1250 coupled to the processor 1210 via computing device connection 1205. The sensor(s) 1250 may include one or more of the sensors in the sensor(s) 1250. For example, the sensor(s) 1250 may include one or more environmental sensors and/or one or more sensors (e.g., the status sensor 370 and/or the PMO sensor 380, or one or more portions thereof) for providing one or more indications of one or more UE conditions.

Computing device architecture 1200 can include a cache of high-speed memory connected directly with, in close proximity to, or integrated as part of processor 1210. Computing device architecture 1200 can copy data from memory 1215 and/or the storage device 1230 to cache 1212 for quick access by processor 1210. In this way, the cache can provide a performance boost that avoids processor 1210 delays while waiting for data. These and other modules can control or be configured to control processor 1210 to perform various actions. Other computing device memory 1215 may be available for use as well. Memory 1215 can include multiple different types of memory with different performance characteristics. Processor 1210 can include any general-purpose processor and a hardware or software service, such as service 1 1232, service 2 1234, and service 3 1236 stored in storage device 1230, configured to control processor 1210 as well as a special-purpose processor where software instructions are incorporated into the processor design. Processor 1210 may be a self-contained system, containing multiple cores or processors, a bus, memory controller, cache, etc. A multi-core processor may be symmetric or asymmetric.

The processor 1210 may also include a communication resource allocation unit 1252. The communication resource allocation unit 1252 may be configured to allocate resources of the computing device architecture 1200 for communication as discussed herein. The communication resource allocation unit 1252 is discussed further below, and the description may refer to the processor 1210 generally, or the computing device architecture 1200 generally, as performing any of the functions of the functional unit 1252.

The communication resource allocation unit 1252 is configured to determine and control which resources to use for communication. The communication resource allocation unit 1252 may be configured to use information from the sensor(s) 1250, the location(s) of the sensor(s) in the computing device architecture 1200, coverage area(s) of the sensor(s) 1250 (e.g., a field of view of a camera), etc. to draw conclusions from the information provided by the sensor(s) 1250 that may affect how the communication resource allocation unit 1252 allocates one or more resources (e.g., (usage of) one or more components of the computing device architecture 1200, energy used by the computing device architecture 1200, etc.) for communication. The communication resource allocation unit 1252 may, for example, determine directionality and/or power to use for communication transmission and/or reception, and/or may determine a quantity of antenna beams and/or a quantity of antennas to use for transmission and/or reception, and/or may determine processing effort (also referred to herein as processing level) (e.g., processing power, bandwidth, and/or time) for communication transmission and/or reception. The communication resource allocation unit 1252 may, for example, save power by selectively transmitting and/or receiving with less than full bandwidth and/or by selectively reducing a message repetition (i.e., how many times that a message is repeatedly transmitted). The communication resource allocation unit 1252 may use power and/or beam management to allocate communication resources, e.g., as discussed herein.

To enable user interaction with the computing device architecture 1200, input device 1245 can represent any number of input mechanisms, such as a microphone for speech, a touch-sensitive screen for gesture or graphical input, keyboard, mouse, motion input, speech and so forth. Output device 1235 can also be one or more of a number of output mechanisms known to those of skill in the art, such as a display, projector, television, speaker device, etc. In some instances, multimodal computing devices can enable a user to provide multiple types of input to communicate with computing device architecture 1200. Communication interface 1240 can generally govern and manage the user input and computing device output. There is no restriction on operating on any particular hardware arrangement and therefore the basic features here may easily be substituted for improved hardware or firmware arrangements as they are developed.

Storage device 1230 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1225, read only memory (ROM) 1220, and hybrids thereof. Storage device 1230 can include services 1232, 1234, 1236 for controlling processor 1210. Other hardware or software modules are contemplated. Storage device 1230 can be connected to the computing device connection 1205. In one aspect, a hardware module that performs a particular function can include the software component stored in a computer-readable medium in connection with the necessary hardware components, such as processor 1210, connection 1205, output device 1235, and so forth, to carry out the function.

In some cases, the computing device architecture 1200 may be a user equipment (UE), server device, or other device that may be coupled to a wireless communications system.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function needs not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An application server including at least one memory and at least one processor coupled to the at least one memory and configured to: determine a plurality of associations among a plurality of assets, wherein each association of the plurality of associations is created between two different assets of the plurality of assets, wherein each of the two different assets is in a same mesh network or different mesh networks; monitor a plurality of messages being communicated corresponding to each association of the plurality of associations; detect an exception has occurred based upon the monitoring; and generate a notification based upon the detected exception.

Aspect 2: The application server of Aspect 1, wherein the at least one processor is configured to determine the plurality of associations in accordance with a plurality of operational flows describing movement of an asset across a plurality of entities of each operational flow of the plurality of operational flows.

Aspect 3: The application server of Aspect 1 or 2, wherein the at least one processor is configured to determine the plurality of associations in accordance with manifestation of a shipment corresponding to an asset of the plurality of assets.

Aspect 4: The application server of any of Aspects 1 to 3, wherein the at least one processor is configured to determine the plurality of associations in accordance with a plurality of exception events.

Aspect 5: The application server of any of Aspects 1 to 4, wherein the plurality of exception events comprises a theft of an asset of the plurality of assets, a fraud, and/or an unexpected event.

Aspect 6: The application server of any of Aspects 1 to 5, wherein the at least one processor is configured to determine the plurality of associations to be active for a time period defined by a start time and an end time.

Aspect 7: The application server of any of Aspects 1 to 6, wherein the at least one processor is configured to terminate or remove an association of the plurality of associations when an asset associated with the association arrives at a destination.

Aspect 8: The application server of any of Aspects 1 to 7, wherein the at least one processor is configured to detect, based upon the plurality of monitored messages, a plurality of events, the plurality of events including at least one of a determination that an asset is stationary, that the asset is moving, that the asset is in an indoor environment, that the asset is in an outdoor environment, that the asset is empty, that the asset is non-empty, that the asset is folded, that the asset is unfolded, that the asset is being loaded, that the asset is being unloaded, or that the asset being in proximity with another asset.

Aspect 9: The application server of any of Aspects 1 to 8, wherein each association of the plurality of associations is configured to allow communication between two assets in the same mesh network or different mesh networks using at least one of a plurality of communication protocols.

Aspect 10: The application server of any of Aspects 1 to 9, wherein the plurality of communication protocols includes at least one of a vehicle-to-vehicle communication protocol, a vehicle-to-everything communication protocol, a Wi-Fi mesh protocol, or a Bluetooth low energy mesh protocol.

Aspect 11: The application server of any of Aspects 1 to 10, wherein each association of the plurality of associations is configured to allow communication between at least two assets of the plurality of assets at an adjustable time interval.

Aspect 12: The application server of any of Aspects 1 to 11, wherein the adjustable time interval is based on a message payload size, a data rate, and a respective battery level corresponding to the two different assets of each association.

Aspect 13: The application server of any of Aspects 1 to 12, wherein a first asset of the two different assets of the plurality of assets comprises one of a vehicle, a pallet, or a container, and a second asset of the two different assets of the plurality of assets comprises another one of the vehicle, the pallet, or the container.

Aspect 14: The application server of any of Aspects 1 to 13, wherein a first asset of the two different assets of the plurality of assets comprises a first vehicle, a first pallet of the first vehicle, or a first container of the first pallet, and a second asset of the two different assets of the plurality of assets comprises a second vehicle, a second pallet of the second vehicle, or a second container of the second pallet.

Aspect 15: A computer-implemented method including: determining a plurality of associations among a plurality of assets, wherein each association of the plurality of associations is created between two different assets of the plurality of assets, wherein each of the two different assets is in a same mesh network or different mesh networks; monitoring a plurality of messages being communicated corresponding to each association of the plurality of associations; detecting an exception has occurred based upon the monitoring; and generating a notification based upon the detected exception.

Aspect 16: The computer-implemented method of Aspect 15, further including determining the plurality of associations in accordance with one or more of: a plurality of operational flows describing movement of an asset across a plurality of entities of each operational flow of the plurality of operational flows, manifestation of a shipment corresponding to the asset, and a plurality of exception events including a theft of the asset, a fraud, and/or an unexpected event.

Aspect 17: The computer-implemented method of Aspect 15 or 16, further including determining the plurality of associations to be active for a time period defined by a start time and an end time, and terminating or removing an association of the plurality of associations when an asset associated with the association arrives at a destination.

Aspect 18: The computer-implemented method of any of Aspects 15 to 17, further including detecting, based upon the plurality of monitored messages, a plurality of events, the plurality of events including at least one of a determination that an asset is stationary, that the asset is moving, that the asset is in an indoor environment, that the asset is in an outdoor environment, that the asset is empty, that the asset is non-empty, that the asset is folded, that the asset is unfolded, that the asset is being loaded, that the asset is being unloaded, or that the asset being in proximity with another asset.

Aspect 19: The computer-implemented method of any of Aspects 15 to 18, wherein each association of the plurality of associations is configured to allow communication between two assets in the same mesh network or different mesh networks using at least one of a plurality of communication protocols, wherein the plurality of communication protocols include at least one of a vehicle-to-vehicle communication protocol, a vehicle-to-everything communication protocol, a Wi-Fi mesh protocol, or a Bluetooth low energy mesh protocol.

Aspect 20: The computer-implemented method of any of Aspects 15 to 19, further comprising configuring each association of the plurality of associations to allow communication between at least two assets of the plurality of assets at an adjustable time interval, wherein the adjustable time interval is based on a message payload size, a data rate, and a respective battery level corresponding to the two different assets of each association.

Aspect 21: The computer-implemented method of any of Aspects 15 to 20, wherein a first asset of the two different assets of the plurality of assets includes one of a vehicle, a pallet, or a container, and a second asset of the two different assets of the plurality of assets includes another one of the vehicle, the pallet, or the container.

Aspect 22: The computer-implemented method of any of Aspects 15 to 21, wherein a first asset of the two different assets of the plurality of assets comprises a first vehicle, a first pallet of the first vehicle, or a first container of the first pallet, and a second asset of the two different assets of the plurality of assets comprises a second vehicle, a second pallet of the second vehicle, or a second container of the second pallet.

Aspect 23: A non-transitory computer-readable medium is provided. The non-transitory computer-readable medium, when executed by at least one processor, causes the at least one processor to perform operations according to any of Aspects 15 to 22.

Aspect 24: An apparatus comprising one or more means for performing operations according to any of Aspects 15 to 22.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An application server comprising:
at least one memory comprising instructions; and
at least one processor coupled to the at least one memory and configured to:
determine a plurality of associations among a plurality of assets, wherein each association of the plurality of associations is created between two different assets of the plurality of assets, wherein each of the two different assets is in a same mesh network or different mesh networks;
monitor a plurality of messages being communicated corresponding to each association of the plurality of associations;
detect an exception has occurred based upon the monitoring; and
generate a notification based upon the detected exception.

2. The application server of claim 1, wherein the at least one processor is configured to determine the plurality of associations in accordance with a plurality of operational flows describing movement of an asset across a plurality of entities of each operational flow of the plurality of operational flows.

3. The application server of claim 1, wherein the at least one processor is configured to determine the plurality of associations in accordance with manifestation of a shipment corresponding to an asset of the plurality of assets.

4. The application server of claim 1, wherein the at least one processor is configured to determine the plurality of associations in accordance with a plurality of exception events.

5. The application server of claim 4, wherein the plurality of exception events comprises a theft of an asset of the plurality of assets, a fraud, and/or an unexpected event.

6. The application server of claim 1, wherein the at least one processor is configured to determine the plurality of associations to be active for a time period defined by a start time and an end time.

7. The application server of claim 1, wherein the at least one processor is configured to terminate or remove an association of the plurality of associations when an asset associated with the association arrives at a destination.

8. The application server of claim 1, wherein the at least one processor is configured to detect, based upon the plurality of monitored messages, a plurality of events, the plurality of events including at least one of a determination that an asset is stationary, that the asset is moving, that the asset is in an indoor environment, that the asset is in an outdoor environment, that the asset is empty, that the asset is non-empty, that the asset is folded, that the asset is unfolded, that the asset is being loaded, that the asset is being unloaded, or that the asset being in proximity with another asset.

9. The application server of claim 1, wherein each association of the plurality of associations is configured to allow communication between two assets in the same mesh network or different mesh networks using at least one of a plurality of communication protocols.

10. The application server of claim 9, wherein the plurality of communication protocols includes at least one of a vehicle-to-vehicle communication protocol, a vehicle-to-everything communication protocol, a Wi-Fi mesh protocol, or a Bluetooth low energy mesh protocol.

11. The application server of claim 1, wherein each association of the plurality of associations is configured to allow communication between at least two assets of the plurality of assets at an adjustable time interval.

12. The application server of claim 11, wherein the adjustable time interval is based on a message payload size, a data rate, and a respective battery level corresponding to the two different assets of each association.

13. The application server of claim 1, wherein a first asset of the two different assets of the plurality of assets comprises one of a vehicle, a pallet, or a container, and a second asset of the two different assets of the plurality of assets comprises another one of the vehicle, the pallet, or the container.

14. The application server of claim 1, wherein a first asset of the two different assets of the plurality of assets comprises a first vehicle, a first pallet of the first vehicle, or a first container of the first pallet, and a second asset of the two different assets of the plurality of assets comprises a second vehicle, a second pallet of the second vehicle, or a second container of the second pallet.

15. A computer-implemented method for association-based tracking, comprising:
determining a plurality of associations among a plurality of assets, wherein each association of the plurality of associations is created between two different assets of the plurality of assets, wherein each of the two different assets is in a same mesh network or different mesh networks;
monitoring a plurality of messages being communicated corresponding to each association of the plurality of associations;
detecting an exception has occurred based upon the monitoring; and
generating a notification based upon the detected exception.

16. The computer-implemented method of claim 15, further comprising determining the plurality of associations in accordance with one or more of: a plurality of operational flows describing movement of an asset across a plurality of entities of each operational flow of the plurality of operational flows, manifestation of a shipment corresponding to the asset, and a plurality of exception events comprising a theft of the asset, a fraud, and/or an unexpected event.

17. The computer-implemented method of claim 15, further comprising determining the plurality of associations to be active for a time period defined by a start time and an end time, and terminating or removing an association of the plurality of associations when an asset associated with the association arrives at a destination.

18. The computer-implemented method of claim 15, further comprising detecting, based upon the plurality of monitored messages, a plurality of events, the plurality of events including at least one of a determination that an asset is stationary, that the asset is moving, that the asset is in an indoor environment, that the asset is in an outdoor environment, that the asset is empty, that the asset is non-empty, that the asset is folded, that the asset is unfolded, that the asset is being loaded, that the asset is being unloaded, or that the asset being in proximity with another asset.

19. The computer-implemented method of claim 15, wherein each association of the plurality of associations is configured to allow communication between two assets in the same mesh network or different mesh networks using at least one of a plurality of communication protocols, wherein the plurality of communication protocols include at least one of a vehicle-to-vehicle communication protocol, a vehicle-to-everything communication protocol, a Wi-Fi mesh protocol, or a Bluetooth low energy mesh protocol.

20. The computer-implemented method of claim 15, further comprising configuring each association of the plurality of associations to allow communication between at least two assets of the plurality of assets at an adjustable time interval, wherein the adjustable time interval is based on a message payload size, a data rate, and a respective battery level corresponding to the two different assets of each association.
